(19) United States
(12) Patent Application Publication
(10) Pub. No.: US 2023/0056433 A1
(43) Pub. Date: Feb. 23, 2023

(54) DATA MANAGEMENT DEVICE AND PROGRAM

(71) Applicant: Hitachi, Ltd., Tokyo (JP)

(72) Inventors: Yoshinori MOCHIZUKI, Tokyo (JP); Naoyuki TAKEDA, Tokyo (JP); Daisuke INABA, Tokyo (JP)

(21) Appl. No.: 17/844,884

(22) Filed: Jun. 21, 2022

(30) Foreign Application Priority Data
Aug. 19, 2021 (JP) 2021-133837

(51) Int. Cl. G06F 16/2457; G06F 16/2458; G06F 16/25; G06F 16/248

(52) U.S. Cl. CPC G06F 16/2457; G06F 16/2477; G06F 16/258; G06F 16/248

(57) ABSTRACT

Provided are a time series data management unit that manages time series data generated in a target system, and a context management unit that manages a context registered by a user in association with time series data managed by a time series data management unit. The context management unit executes a process of extracting time series data associated with a context set as a search target by the user out of the managed time series data.

### CROSS-REFERENCE TO RELATED APPLICATION

The present application claims priority from Japanese application JP2021-133837, filed on Aug. 19, 2021, the contents of which is hereby incorporated by reference into this application.

### BACKGROUND OF THE INVENTION

### 1. Field of the Invention

The present invention relates to a data management device and a program for managing time series data.

### 2. Description of the Related Art

Conventionally, many techniques for improving searchability of a large amount of time series data acquired from a control system to be monitored have been proposed. For example, JP 2010-506311 A discloses a time series search engine including “a means for time indexing time stamped events generated by time stamping a time series data stream to create time bucking indices; a means for receiving a time series search request; and a means for executing the time series search request, at least in part, by searching the time bucketed indices”. For example, the time series data is log data output from an application server or a web server. This method enables the time series data to be automatically indexed.

### SUMMARY OF THE INVENTION

However, in the method described in JP 2010-506311 A, a user who uses the index needs to know what kind of index is assigned to the time series data according to log data output from the application server or the web server. In addition, the index generated by the computer is not necessarily an index name that is easy for the user to use, and is also likely to impair convenience of the user.

In view of the above circumstances, there has been a demand for a method for searching for specific data desired by a user from a large amount of time series data without impairing convenience of the user.

In order to solve the above problem, a data management device according to an aspect of the present invention includes: a time series data management unit that manages time series data generated in a target system; and a context management unit that manages a context registered by a user in association with the time series data managed by the time series data management unit. The context management unit executes a process of extracting time series data associated with the context set as a search target by the user out of the managed time series data.

According to at least one aspect of the present invention, it is possible to search for the specific data desired by the user from a large amount of the time series data without impairing the convenience of the user.

Other objects, configurations, and effects which have not been described above become apparent from embodiments to be described hereinafter.

### BRIEF DESCRIPTION OF THE DRAWINGS

FIG. 1 is a block diagram illustrating an example of a configuration of a data management device according to a first embodiment of the present invention;

FIG. 2 is a table illustrating an example of a structure of a field data storage table according to the first embodiment of the present invention;

FIG. 3 is a table illustrating an example of a structure of a context storage table according to the first embodiment of the present invention;

FIG. 4 is a table illustrating an example of a structure of a context assignment management table according to the first embodiment of the present invention;

FIG. 5 is a sequence chart illustrating an example of a procedure of data management by the data management device according to the first embodiment of the present invention;

FIG. 6 is a flowchart illustrating an example of a procedure of field data collection processing by the data management device according to the first embodiment of the present invention;

FIG. 7 is a flowchart illustrating an example of a procedure of field data acquisition processing, context registration processing, context assignment processing, and context search processing by the data management device according to the first embodiment of the present invention;

FIG. 8 is a view illustrating an example of a screen used in the context registration processing by the data management device according to the first embodiment of the present invention;

FIG. 9 is a view illustrating a first example of a screen used in the context assignment processing by the data management device according to the first embodiment of the present invention;

FIG. 10 is a view illustrating a second example of the screen used in the context assignment processing by the data management device according to the first embodiment of the present invention;

FIG. 11 is a view illustrating an example of a screen used in the context search processing by the data management device according to the first embodiment of the present invention;

FIG. 12 is a block diagram illustrating an example of a configuration of a data management device according to a second embodiment of the present invention;

FIG. 13 is a table illustrating an example of a structure of a conversion rule management table according to the second embodiment of the present invention;

FIG. 14 is a sequence chart illustrating an example of a procedure of data management by the data management device according to the second embodiment of the present invention;

FIG. 15 is a flowchart illustrating an example of a procedure of conversion rule registration processing, field data acquisition processing, context registration processing, context assignment processing, and context search processing by the data management device according to the second embodiment of the present invention;

FIG. 16 is a view illustrating an example of a screen used in the conversion rule registration processing according to the second embodiment of the present invention; and

FIG. 17 is a view illustrating a context assignment screen as a display example of a data name of field data after application of a conversion rule according to the second embodiment of the present invention.

### DESCRIPTION OF THE PREFERRED EMBODIMENTS

Hereinafter, embodiments of the present invention will be described with reference to the accompanying drawings. In the present specification and attached drawings, constituent elements having substantially the same function or configuration will be denoted by the same reference sign, and the redundant description thereof will be omitted.

### First Embodiment

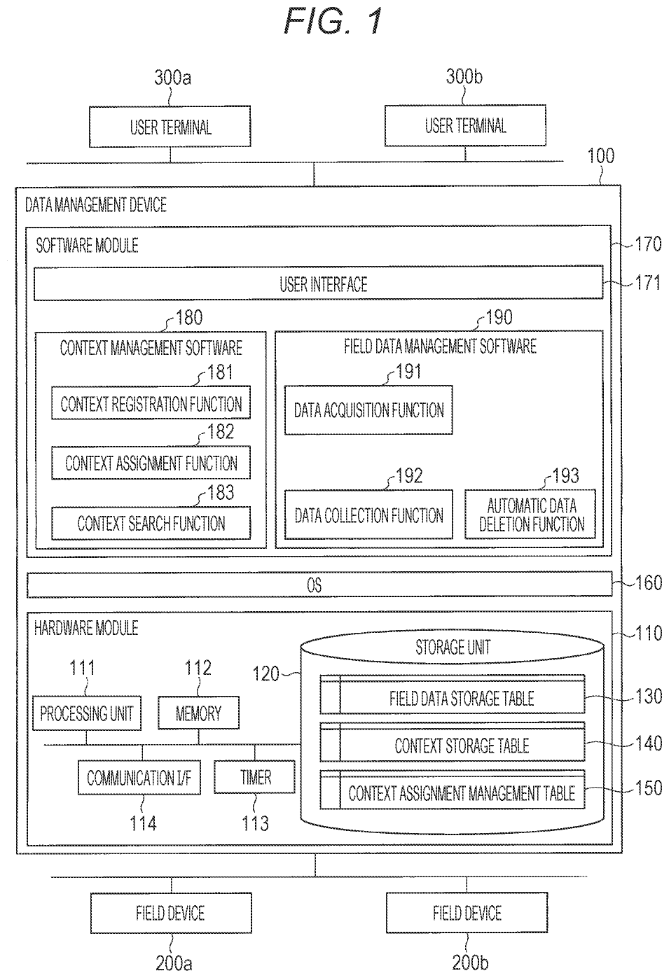

First, an example of a system to which a data management device according to a first embodiment of the present invention is applied will be described with reference to FIG. 1.

[Configuration of Entire System Including Data Management Device]

FIG. 1 is a diagram illustrating an example of an overall configuration of the system to which the data management device according to the first embodiment of the present invention is applied and an example of a configuration of the data management device.

As illustrated in FIG. 1, a data management device 100 is connected to field devices 200a and 200b via a network. The data management device 100 collects time-series operation data, sensor data, or the like (hereinafter collectively referred to as “field data”) generated by the field devices 200a and 200b through the network, and provides the collected field data to user terminals 300a and 300b. In the present specification, discrete data collected in time series from a field device 200 is referred to as “time series data”.

The field devices 200a and 200b and the user terminals 300a and 300b will be described as the field device 200 and a user terminal 300, respectively, when not distinguished. In addition, the number of the field devices 200 or the user terminals 300 is not limited to the number illustrated in FIG. 1.

The field devices 200a and 200b are devices installed in a control system to be monitored, such as a factory or a plant, and correspond to supervisory control and data acquisition (SCADA), a distributed control system (DCS), a controller, and the like.

The user terminals 300a and 300b are terminals used by a user, and correspond to a general-purpose computer, such as a personal computer or a tablet computer, including an input device and a display device. The user can display each screen on the display device, which will be described later, move and click a pointer on each screen, input text, and the like by the input device of the user terminal 300. The user terminals 300a and 300b execute machine learning such as visualization and preventive maintenance of a field using the field data collected by the data management device 100. In the present specification, the field data may be simply described to as “data”.

### [Configuration of Data Management Device]

The data management device 100 corresponds to a general-purpose computer such as a personal computer, a workstation, or the like. The data management device 100 includes a hardware module 110, an OS 160, and a software module 170.

The hardware module 110 includes a processing unit 111 configured using a central processing unit (CPU) or the like, a memory 112 configured for the operation of the OS, a computer program, and the like, and a timer 113 configured to implement the fixed cycle operation of software in the software module 170. In addition, the hardware module 110 includes a communication interface (denoted as a communication I/F in FIG. 1) 114 configured to perform data communication with the field device 200 and the user terminal 300, and a storage unit 120. Blocks are connected to transmit and receive data to and from each other through a system bus.

The storage unit 120 is configured using a mass storage or the like. For example, a hard disk device or the like can be used as the mass storage. The storage unit 120 stores a field data storage table 130, a context storage table 140, and a context assignment management table 150. In addition, the storage unit 120 stores a cycle when the software operates in a fixed cycle. In addition, the storage unit 120 stores a computer program executed by the processing unit 111, a parameter, and the like. The processing unit 111 reads a program code of software for implementing each function according to this embodiment from the storage unit 120 and executes the program code to perform various calculations and control.

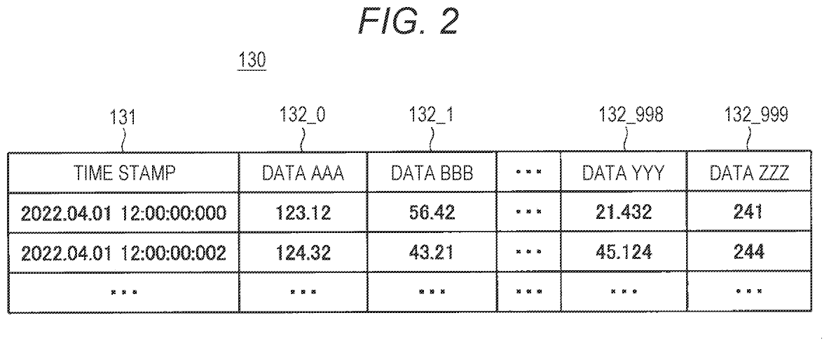

Next, the field data storage table 130, the context storage table 140, and the context assignment management table 150 will be described with reference to FIG. 2.

### (Structure of Timed Log Storage Table)

FIG. 2 is a table illustrating an example of a structure of the field data storage table 130.

The field data storage table 130 is a table that stores time series field data collected by a data collection function 192 (see FIG. 1) from the field device 200 through the communication I/F 114. The field data storage table 130 has fields of “time stamp 131” and “data 132_0, 132_1, . . . , and 132_999”. The pieces of data 132_0, 132_1, . . . , and 132_999 will be collectively described as data 132 when not distinguished from each other.

The time stamp 131 is a time stamp assigned when the field device 200 transmits the field data held by the field device 200 to the data management device 100 in response to a field data collection request message of the data management device 100. The time stamp 131 indicates a date and time when the field device 200 has generated or acquired the field data.

The data 132 (data 132_0, 132_1, . . . , and 132_999) is data (field data) collected from the field device 200 by the data management device 100 using the field data collection request message. For example, in FIG. 2, a value of time series data of a data name “Data AAA” is stored in the data 132_0. The data 132 corresponds to data such as data related to a temperature, a pressure, a flow rate, a speed, a current, and a voltage or data related to an operation time.

Although the field data storage table 130 is created for each of the field devices 200 in this embodiment, but pieces of field data of the plurality of field devices 200 may be collected in one field data storage table 130. In a case where data names overlap, it is desirable to divide the field data storage table 130 for each of the field devices 200.

### (Structure of Context Storage Table)

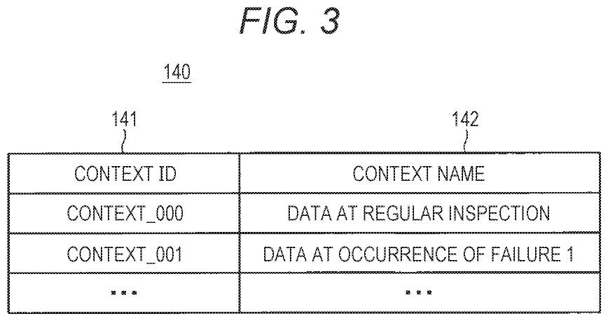

FIG. 3 is a table illustrating an example of a structure of the context storage table 140.

The context storage table 140 is a table in which a context registration function 181 (see FIG. 1) stores a context that the user desires to register using the user terminal 300 through a user interface 171. The context is information describing time series data. For example, in a case where time series data at a certain time point is data of a maintenance mode of a field device, a context of “maintenance mode” is assigned to the time series data. The context storage table 140 has fields of “context ID 141” and “context name 142”.

The context ID 141 is an identifier for uniquely identifying a context name, and is an ID given when the context registration function 181 registers a context. In FIG. 3, numerals are used for context IDs, but alphabets, combinations thereof, or the like may be used.

The context name 142 is a name of a context that the user desires to assign to time series data, and corresponds to, for example, a name indicating a state of the field device 200 such as “Data at regular inspection” or “Data at occurrence of Failure 1”.

### (Structure of Context Assignment Management Table)

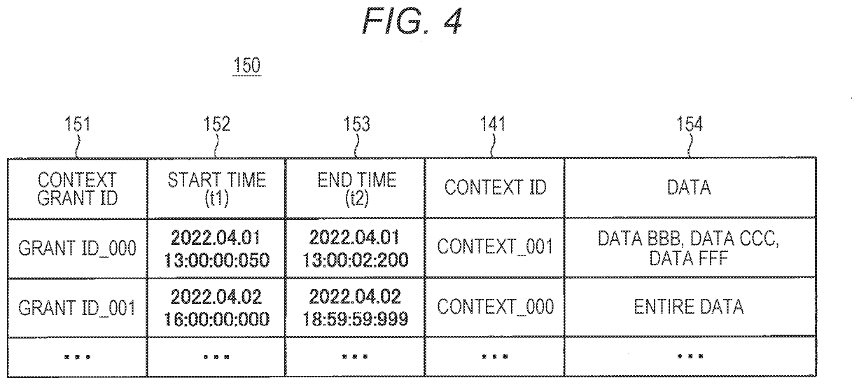

FIG. 4 is a table illustrating an example of a structure of the context assignment management table.

The context assignment management table 150 is a table in which a context assignment function 182 (see FIG. 1) manages a relationship between time series data and a context assigned to the time series data when the user assigns the context to the time series data using the user terminal 300 through the user interface 171 (see FIG. 1). The context assignment management table 150 includes fields of “context assignment ID 151”, “start time 152”, “end time 153”, “context ID 141”, and “data 154”.

The context assignment ID 151 is an identifier for uniquely identifying a relationship between time series data and a context assigned to the time series data. The context assignment ID 151 is an ID assigned when the context assignment function 182 stores the relationship between the time series data and the context assigned to the time series data in the context assignment management table 150. In the context assignment ID 151, a plurality of context assignment IDs can be registered for the same context ID. In FIG. 4, numerals are used for context assignment IDs, but alphabets, combinations thereof, or the like may be used.

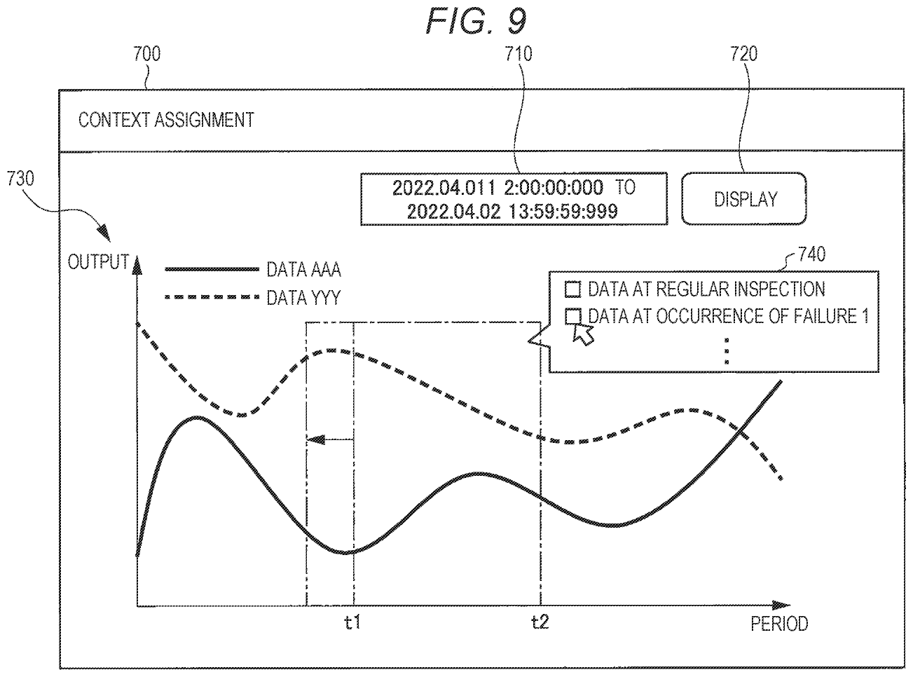

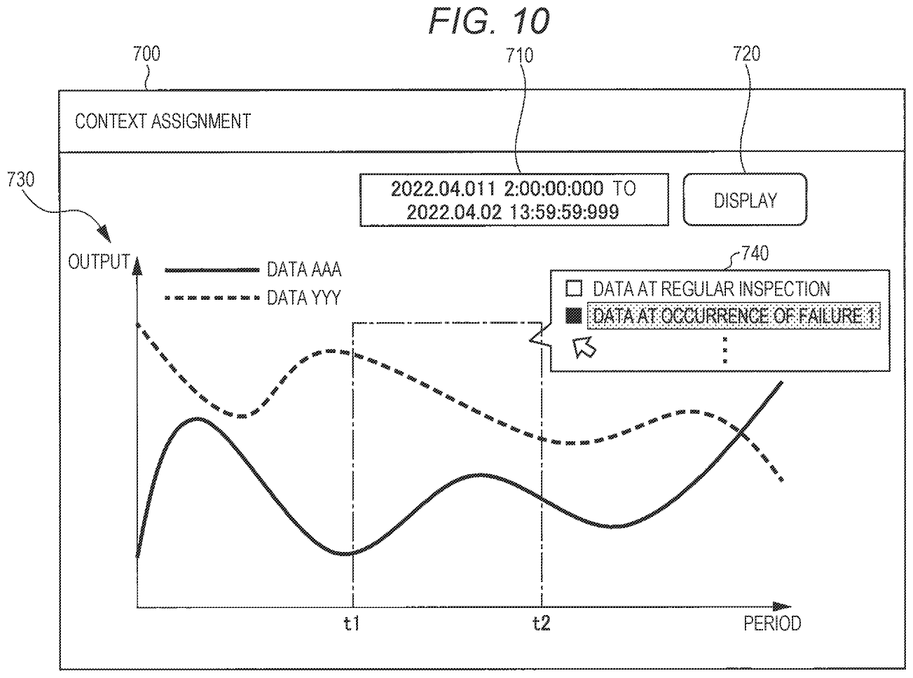

The start time 152 and the end time 153 are a start time and an end time of time series data to which a context is assigned. For example, in a case where the user has assigned a context to a time series data between 13:00:00.050 on Apr. 1, 2022 and 13:00:02.200 on Apr. 1, 2022, the context assignment function 182 stores 13:00:00.050 on Apr. 1, 2022 and 13:00:02.200 on Apr. 1, 2022 for the start time 152 and the end time 153, respectively. The start time 152 and the end time 153 correspond to a start time t1 and an end time t2 indicated in a graph 730 of FIGS. 9 and 10 to be described later.

The data 154 is data to which the user has assigned a context. For example, in a case where the user assigns a context having a context ID of context_001 to pieces of data which is time series data of “Data BBB”, “Data CCC”, and “Data FFF” between 13:00:00.050 on Apr. 1, 2022 and 13:00:02.200 on Apr. 1, 2022, the context assignment function 182 stores the “Data BBB”, the “Data CCC”, and the “Data FFF” in the data 154. In a case where the user assigns a context to all types of data stored in the field data storage table 130, a value that can be understood as the entire data may be stored in the data 154.

Each of the tables stored in the storage unit 120 has been described as above. The description returns to the data management device 100 of FIG. 1.

The OS 160 is basic software (an operating system) that integrally controls the operation of the data management device 100.

The software module 170 is software that operates on the data management device 100, and includes the user interface 171, context management software 180, and field data management software 190.

The user interface 171 is an interface configured to allow the user to use the context management software 180 and the field data management software 190 using the user terminal 300, and corresponds to a web interface or the like.

### [Context Management Software]

The context management software 180 is software by which the user assigns a context to time series data collected from the field device 200 stored in the field data storage table 130, searches for the time series data using the assigned context, and the like through the user interface 171 using the user terminal 300. The context management software 180 includes the context registration function 181, the context assignment function 182, and a context search function 183.

The context registration function 181 is a 6-3 function through the user interface 171.

When the user assigns a context stored in the context storage table 140 to time series data stored in the field data storage table 130 through the user interface 171, the context assignment function 182 is a function of storing the time series data and information regarding the assigned context in the context assignment management table 150.

The context search function 183 is a function of searching for specific time series data from among pieces of time series data stored in the field data storage table 130 by the user through the user interface 171 using a context stored in the context storage table 140.

For example, assumed is a case where the context of “Data at regular inspection” is assigned between 13:00:00.050 on Apr. 1, 2022 and 13:00:02.200 on Apr. 1, 2022 of “Data BBB”, “Data CCC”, and “Data FFF” and such information is stored in the context assignment management table 150. In a case where the user instructs search using the “Data at regular inspection” as a keyword, the context search function 183 refers to the context assignment management table 150 to return “Data BBB”, “Data CCC”, and “Data FFF” between 13:00:00.050 on Apr. 1, 2022 and 13:00:02.200 on Apr. 1, 2022 to the user (user terminal 300) as a search result.

The context management software 180 has been described as above. When a context is stored in the context storage table 140 or when time series data and information regarding a context assigned to the time series data are stored in the context assignment management table 150, a user ID for uniquely identifying a user who has executed such processing is assigned so that a search can be performed using a context in accordance with the user at the time of executing the context search function 183.

### [Field Data Management Software]

Next, the field data management software 190 will be described.

The field data management software 190 is software that executes processing or the like in a case where the user desires to acquire data stored in the field data storage table 130 through the user interface 171 while storing data collected from the field device 200 in the field data storage table 130, and includes a data acquisition function 191, the data collection function 192, and an automatic data deletion function 193.

The data acquisition function 191 is a function of executing processing in response to an acquisition request for time series data stored in the field data storage table 130 from the user through the user interface 171. For example, in a case where there is an acquisition request for Data AAA between 12:00:00 on Apr. 1, 2022 and 12:59:59.999 on Apr. 1, 2022, the data acquisition function 191 refers to the field data storage table 130 and returns the corresponding data to the user. Note that the data acquisition function 191 does not perform data acquisition using the context, and performs data acquisition with reference to only the field data storage table 130.

The data collection function 192 is a function of collecting data from the field device 200 through the communication I/F 114 and storing the collected data in the field data storage table 130.

The automatic data deletion function 193 is a function of regularly deleting past old data in order to prevent the field data storage table 130 from being excessively enlarged.

For example, assumed is a case where data of three or more years ago is stored in the field data storage table 130, and the automatic data deletion function 193 is set to automatically delete the data of three or more years ago without user's approval. In this case, the automatic data deletion function 193 deletes data the stored in the field data storage table 130 and obtained three or more years ago. Further, the automatic data deletion function 193 refers to the start time 152 and the end time 153 of the context assignment management table 150, and performs change or deletion in conformity with the field data storage table 130. when there is a record for which a time of three or more years ago is set similarly to the field data storage table 130.

The field data management software 190 has been described as above. The above is the description of the data management device 100.

### (Data Management by Data Management Device)

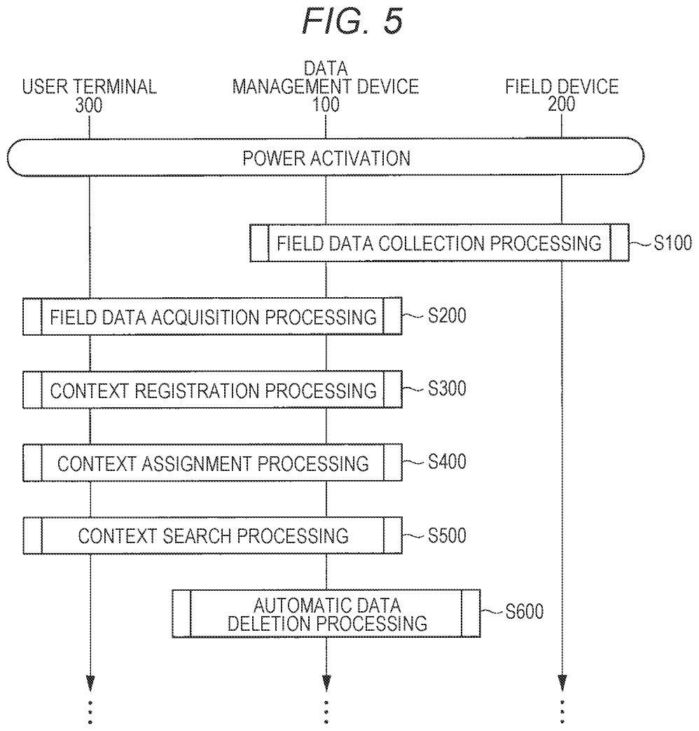

Next, data management by the data management device 100 will be described with reference to FIG. 5.

FIG. 5 is a sequence chart illustrating an example of a procedure of the data management by the data management device 100.

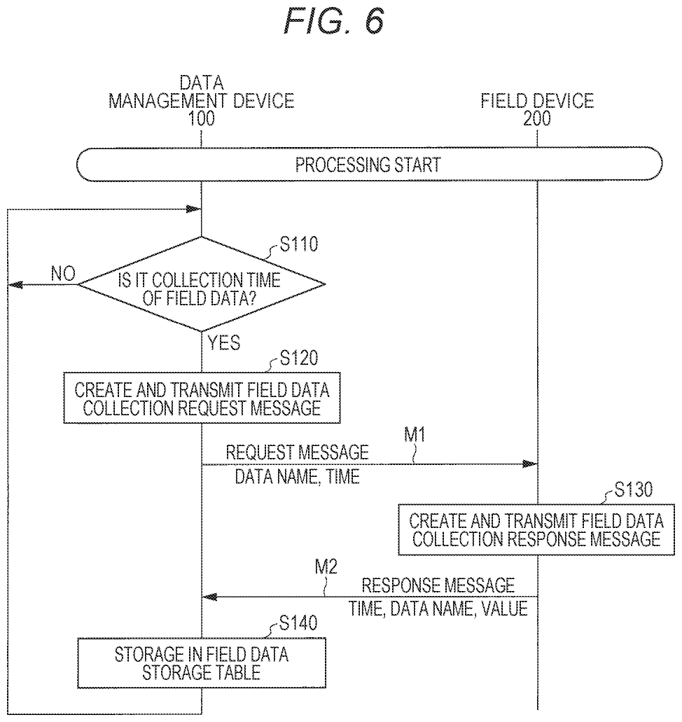

The processing unit 111 executes a control program (the context management software 180 and/or the field data management software 190) stored in the storage unit 120, thereby implementing the procedure of the data management illustrated in FIG. 5. The same applies to FIGS. 6, 7, 14, and 15 to be described later.

After power activation, the data management device 100 starts data communication with the field device 200 and the user terminal 300 using the communication I/F 114. Each processing other than data communication between the field device 200 and the data management device 100 in the user terminal 300 is unique processing, and thus, a detailed description thereof will be omitted.

### (Field Data Collection Processing)

After the power activation, the data management device 100 executes field data collection processing (S100) to collect field data from the field device 200. Here, the field data collection processing by the data management device 100 will be described with reference to FIG. 6.

FIG. 6 is a flowchart illustrating an example of a procedure of field data collection processing in step S100 by the data management device 100.

The data management device 100 uses the timer 113 to confirm whether it is time (a cycle) to collect field data from the field device 200 (S110). When it is not the time to collect field data (it is determined as NO in S110), the data management device 100 returns to determination processing in step S110 and executes the determination processing in step S110 again after a lapse of a certain period of time.

When it is the time to collect field data (it is determined as YES in S110), the data management device 100 creates a field data collection request message M1 using the data collection function 192, and transmits the field data collection request message M1 to the field device 200 using the communication I/F 114 (S120). The field data collection request message M1 includes information such as a “data name” that is desired to be acquired from the field device 200 and “time” when the acquisition is desired to be performed. When the “data name” of field data to be acquired between the data management device 100 and the field device 200 is determined, the information included in the field data collection request message may be only the “time”.

The field device 200 that has received the field data collection request message M1 generates field data corresponding to the designated data name and time, creates a field data collection response message M2, and transmits the field data collection response message M2 to the data management device 100 (S130). The field data collection response message M2 includes information such as the “time”, the “data name”, and a “value” of field data indicated by the data name and the time.

The data collection function 192 that has received the field data collection response message M2 using the communication I/F 114 confirms the response message, and stores the time, the data name, and the value of the field data in the field data storage table 130 (S140). After the processing of step S140, the processing returns to the determination processing of step S110, and the above processing is repeated.

The field data collection processing has been described as above. Although a form of data communication in which the data management device 100 transmits the field data collection request message M1 to the field device 200 using the timer 113 has been described in this embodiment, but the present invention is not limited to this example. For example, a form of data communication in which the field device 200 regularly transmits field data held by the field device 200 to the data management device 100 may be adopted.

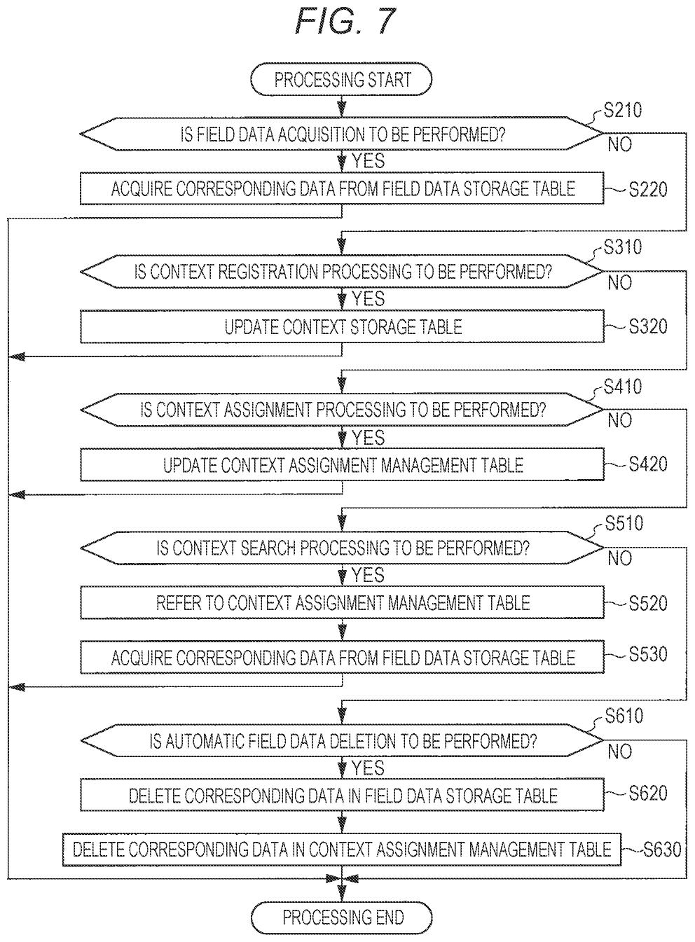

The description returns to the sequence chart of the data management by the data management device 100 illustrated in FIG. 5. Field data acquisition processing (S200), context registration processing (S300), context assignment processing (S400), and context search processing (S500) by the data management device 100 will be described with reference to FIG. 7.

FIG. 7 is a flowchart illustrating an example of a procedure of the field data acquisition processing, the context registration processing, the context assignment processing, and the context search processing from steps S200 to S500 which are performed by the data management device 100.

### (Field Data Acquisition Processing)

First, the field data acquisition processing in step S200 will be described.

When the user desires to acquire field data stored in the field data storage table 130 of the data management device 100 through the user terminal 300, the field data acquisition processing to be described below is executed (S200 in FIG. 3). The field data acquired by the user terminal 300 can be used for the subsequent context registration, context assignment, and context search.

In FIG. 7, the data acquisition function 191 of the field data management software 190 determines whether to perform the field data acquisition (S210). Specifically, the data acquisition function 191 determines whether the data management device 100 has received a field data acquisition request message from the user terminal 300 through the communication I/F 114. When the field data acquisition request message has not been received (it is determined as NO in S210), the processing proceeds to step S310.

On the other hand, when the data management device 100 receives the field data acquisition request message (it is determined as YES in S210), the data acquisition function 191 refers to the field data storage table 130 and acquires field data corresponding to the field data acquisition request message. Then, after acquiring the corresponding field data, the data acquisition function 191 generates a field data acquisition response message, and transmits the field data acquisition response message together with the field data to the user terminal 300 through the communication I/F 114 (S220). After the processing in step S220, the processing of this flowchart is ended.

Note that the field data acquisition request message includes information such as a “data name” that the user terminal 300 desires to acquire from the data management device 100 and “time” when the acquisition is desired to be performed. In addition, the field data acquisition response message includes information such as the “time”, the “data name”, and a “value” of field data indicated by the data name and the time.

The field data acquisition processing has been described as above.

### (Context Registration Processing)

Next, the context registration processing in step S300 will be described.

In a case where the user desires to register a context to be assigned to field data through the user terminal 300, the following context registration processing is executed (S300 in FIG. 3).

In FIG. 7, the context registration function 181 of the context management software 180 determines whether to perform the context registration processing (S310). Specifically, the context registration function 181 determines whether the data management device 100 has received a context registration request message from the user terminal 300 through the communication I/F 114. When the context registration request message has not been received (it is determined as NO in S310), the processing proceeds to step S410.

On the other hand, when the data management device 100 receives the context registration request message (it is determined as YES in S310), the context registration function 181 updates a content of the context storage table 140 based on a content of the request (S320). After the processing in step S320, the processing of this flowchart is ended.

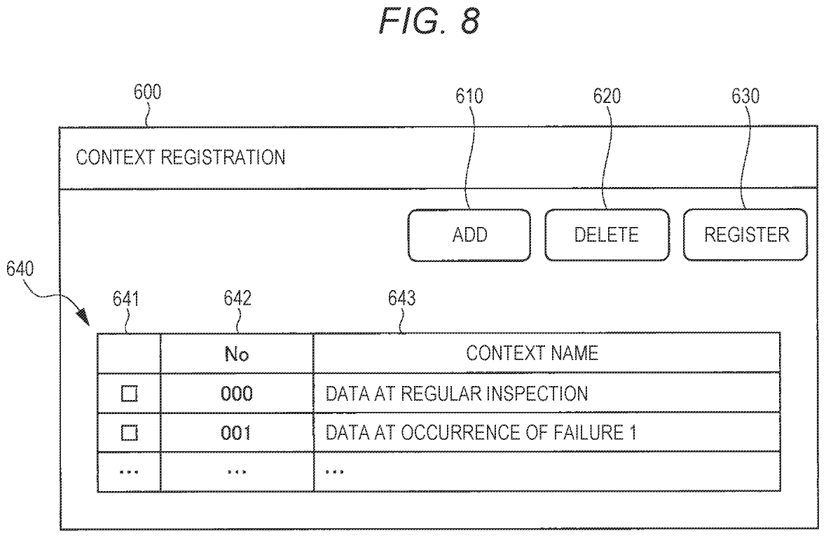

FIG. 8 is a view illustrating an example of a screen used in the context registration processing by the data management device 100. FIG. 8 illustrates an example of a context registration screen 600 prepared as the user interface 171 by the data management device 100. The context registration screen 600 is displayed on the display device of the user terminal 300. The same applies to FIGS. 9 to 11 to be described later.

The context registration screen 600 includes, for example, an add button 610, a delete button 620, a register button 630, and a context registration table 640. The context registration table 640 has fields of a check field 641, a context number 642, and a context name 643.

The check field 641 includes a check box. The user can select a desired record by operating the input device of the user terminal 300 to put a check mark in the check box.

The context number 642 indicates a number of a record constituting the context registration table 640. For example, when the context assignment function 182 adds a new record, a number obtained by adding “1” to the number of the current context number is assigned and displayed.

The context name 643 corresponds to the context name 142 of FIG. 3. In this embodiment, the user can input a name of a context desired to be registered by a free word. Note that it may be configured such that a plurality of names of context candidates are prepared in advance to allow the user to select a context to be registered from among the context candidates displayed in a pull-down menu or the like.

When the user presses the add button 610 on the context registration screen 600, a new column (record) is added to the context registration table 640, and transition to a context input mode is performed. In the context input mode, the user can input a name of a context to be assigned to the field data to the newly added record.

When the user presses the delete button 620, the context registration function 181 deletes a context, selected in the context registration table 640 through the user interface 171, from the context storage table 140.

When the user presses the register button 630, the context registration function 181 stores a content, set by the user to the context name 643 of the context registration table 640 through the user interface 171, in the context storage table 140.

Although an example of the user interface 171 using the context registration screen 600 has been described in this embodiment, an interface other than the screen may be used.

The context registration processing has been described as above.

### (Context Assignment Processing)

Next, the context assignment processing in step S400 will be described.

In a case where the user desires to assign a context to field data through the user terminal 300, the following context assignment processing is executed (S400 in FIG. 3).

In FIG. 7, the context assignment function 182 of the context management software 180 determines whether to perform the context assignment processing (S410). Specifically, the context assignment function 182 determines whether the data management device 100 has received a context assignment request message from the user terminal 300 through the communication I/F 114. When the context assignment request message has not been received (it is determined as NO in S410), the processing proceeds to step S510.

On the other hand, when the data management device 100 receives the context assignment request message (it is determined as YES in S410), the context assignment function 182 updates a content of the context assignment management table 150 based on a content of the request (S420). After the processing in step S420, the processing of this flowchart is ended.

### First Example of Context Assignment

First, a first example of a screen used in the context assignment processing by the data management device 100 will be described with reference to FIG. 9.

FIG. 9 is a view illustrating the first example of the screen used in the context assignment processing. FIG. 9 illustrates an example of a context assignment screen 700 prepared as the user interface 171 by the data management device 100.

The context assignment screen 700 includes, for example, a period designation field 710, a display button 720, a graph 730, and a context list 740.

The period designation field 710 is a field in which the user designates a period for display when a selected type of field data is displayed on the graph 730. The period designated in the period designation field 710 corresponds to a period from the start time t1 to the end time t2 indicated in the graph 730. A method for designating the period may be a method in which the user directly inputs the start time and the end time using a keyboard or the like, or a method in which the period is designated by a scrolling operation using a mouse or the like.

The display button 720 is a button for instructing to display field data of a type selected by the user on the graph 730.

The horizontal axis of the graph 730 represents a period, and the vertical axis represents an output (data value). The start time t1 and the end time t2 indicated by broken lines are designated in the period designation field 710, and correspond to the start time 152 and the end time 153 of the context assignment management table 150 (FIG. 4), respectively. The period represented by the start time t1 and the end time t2 may be displayed using oblique lines or colors such that the user can easily recognize the period. In FIG. 9, changes in “Data AAA” and “Data YYY” are displayed as time series field data. The graph 730 represents at least field data for a period that is longer than a period designated in the period designation field 710. As a result, the user can confirm the change in the field data even in the period before and after the period for which the context is to be assigned, which contributes to appropriate context assignment.

In the context list 740, a check field is provided for each context name. In the context list 740, for example, contexts are displayed by a pull-down menu or scroll, and a hidden context is displayed by a clicking or scrolling operation performed using the mouse.

On the context assignment screen 700, the user selects a type (data name) and a period of field data desired to be displayed on the screen, and then, presses the display button 720. When detecting that the display button 720 is pressed, the data acquisition function 191 acquires field data that is indicated by the type and period of the field data selected by the user from the field data storage table 130 and displays the field data as the graph 730 on the context assignment screen 700. Note that a well-known and commonly used technique can be used as a method by which the user selects the type (data name) of the field data when displaying the graph 730, and thus, a detailed description thereof is omitted here.

When the user selects the type and period of the field data to which the user desires to assign the context using the mouse or the like, the context assignment function 182 acquires all the contexts stored in the context storage table 140 and displays the contexts on the context assignment screen 700 as a context list 740. For example, the period from the start time t1 to the end time t2 can be also adjusted as the user dragging the pointer to be aligned with a position of a one-dot chain line representing the start time t1 or the end time t2 and releasing the dragging at a movement destination. The period displayed in the period designation field 710 also changes in accordance with such an operation. In the example of FIG. 9, the start time is moved to time earlier than the start time t1, so that a maximum value of the “Data AAA” and a minimum value of the “Data YYY” are included in the designated period. As a result, the user can give assign the context in association with a characteristic part (period) of the field data.

Next, when the user checks the check field of the displayed context list 740 and selects the context desired to be assigned, the context assignment function 182 stores information such as the type, period, and context name of the selected field data in the context assignment management table 150. Note that the context assignment function 182 may be configured to store these pieces of information in the context assignment management table 150 by an operation such as pressing a confirmation button (not illustrated) or closing the context assignment screen 700.

When the user performs an operation of deleting information on a context that has already been assigned, the context assignment function 182 deletes the information related to the deleted context from the context assignment management table 150. For example, the context selected for the field data can be deleted by unchecking the context desired to be deleted in the context list 740.

Note that it may be configured such that a plurality of names of context candidates are prepared in advance in the context list 740 to allow the user to select a context desired to be assigned to target field data from among the context candidates displayed in a pull-down menu or the like. In this case, the context registration processing described with reference to FIG. 8 can be omitted.

### Second Example of Context Assignment

Next, a second example of the screen used in the context assignment processing by the data management device 100 will be described with reference to FIG. 10.

FIG. 10 is a view illustrating the second example of the screen used in the context assignment processing.

In the first example of the context assignment illustrated in FIG. 9, an example in which no context is assigned to the type and period of the field data selected by the user has been illustrated. In the second example of the context assignment, in a case where there is a context already associated with selected type and period of field data, the context is clearly indicated to be recognizable. For example, in FIG. 10, the context “Data at occurrence of Failure 1” associated with the type and period of the field data selected in FIG. 9 is highlighted using a frame and dots in the context list 740. A method for the highlighting is not limited to this example, and color coding or the like may be used.

The user can uncheck “Data at occurrence of Failure 1” to select another context, or add a new context while leaving “Data at occurrence of Failure 1”. Since the context already associated with the context list 740 is displayed to be recognizable in this manner, the user can select a context to be assigned after grasping the context already associated with the type and period of the target field data.

### Third Example of Context Assignment

Although it is assumed that the period of the field data for which the context is already registered is longer than and completely included in the period of the field data designated in the period designation field 710 in the second example of the context assignment, the present invention is not limited to this example. That is, it suffices that at least a part of the designated period of the field data overlaps with the period of the field data for which the context is already registered. The context assignment function 182 displays the context of the field data with a partially overlapping period for the selected type and period of the field data in the context list 740.

In this manner, the context assignment function 182 can efficiently extract the already registered context for the selected type and period of the field data and display the context to the user.

The context assignment processing has been described as above.

### (Context Search Processing)

Next, the context search processing in step S500 will be described.

In a case where the user desires to search for field data using the assigned context through the user terminal 300, the following context search processing is executed (S500 in FIG. 3).

In FIG. 7, the context search function 183 of the context management software 180 determines whether to perform the context search processing (S510).

Specifically, the context search function 183 determines whether the data management device 100 has received a context search request message from the user terminal 300 through the communication I/F 114. When the context search request message has not been received (it is determined as NO in S510), the processing proceeds to step S610.

On the other hand, when the data management device 100 receives the context search request message (it is determined as YES in S510), the context search function 183 refers to the context assignment management table 150 based on a content of the request, and acquires a type and a period of field data to which the context designated by the user is assigned (S520). Then, the context search function 183 acquires the corresponding field data from the field data storage table 130 based on the acquired information, and returns the corresponding field data to the user (S530). After the processing in step S530, the processing of this flowchart is ended.

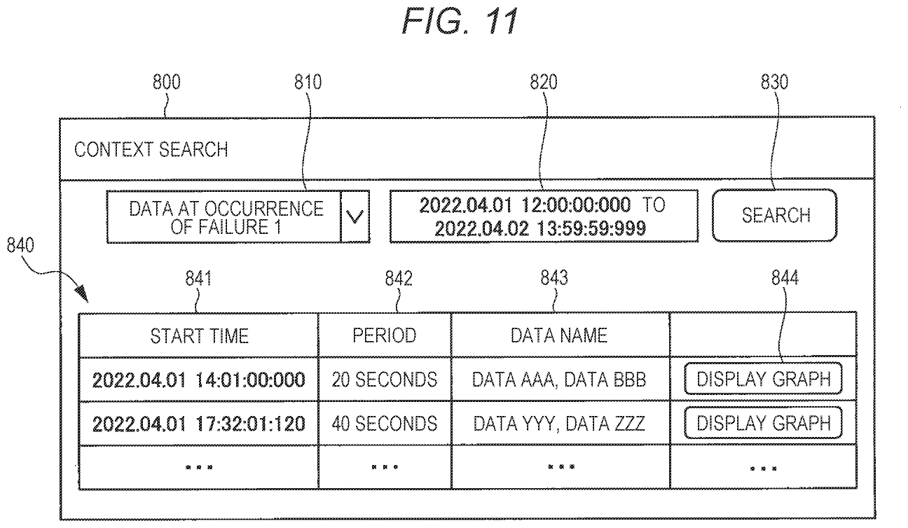

FIG. 11 is a view illustrating an example of a screen used in the context search processing by the data management device 100. FIG. 11 illustrates an example of a context search screen prepared as the user interface 171 by the data management device 100.

A context search screen 800 includes, for example, a context selection field 810, a period designation field 820, a search button 830, and a search result table 840. The search result table 840 includes fields of a start time 841, a period 842, a data name 843, and a graph display button 844.

In the context selection field 810, the user can select a context desired to be searched by operating the input device of the user terminal 300. For example, in the context selection field 810, contexts are displayed as a pull-down menu or scroll.

The period designation field 820 is a field for designating a period of the field data to which the context as the search target is assigned.

The search button 830 is a button configured to allow the user to instruct execution of the context search.

The search result table 840 is a table that displays a result of the context search under a designated condition.

The start time 841 indicates a start time of the field data to which the searched context is assigned.

The period 842 is a time from the start time to the end time of the field data to which the searched context is assigned.

The data name 843 indicates a name of the field data.

The graph display button 844 is a button configured to allow the user to display the corresponding field data in the form of the graph 730.

On the context search screen 800, the user inputs a “context name” and a “period” to be searched in the context selection field 810 and the period designation field 820, and presses the search button 830. When detecting that the search button 830 is pressed, the context search function 183 refers to the context assignment management table 150 and extracts a start time, an end time, and a data name corresponding to the “context name” and the “period” input by the user. Then, the context search function 183 displays the extracted result in the search result table 840 of the context search screen 800.

Next, in a case where there is a search result that the user desires to display as a graph among the search results displayed in the search result table 840, the user presses the graph display button 844. When the graph display button 844 is pressed, the context search function 183 acquires field data corresponding to a data name, a start time, and an end time of the search result (record) from the field data storage table 130. Then, the context search function 183 displays the field data acquired from the field data storage table 130 in the graph (not illustrated).

### (Modification of Context Search Screen)

Here, a modification of the context search screen 800 will be described. In FIG. 11, it is assumed that a period designated in the period designation field 820 is longer than a period indicated by the period 842 which is a search result. However, even if the period of field data to which a context as a search target is assigned is not completely included in the period designated in the period designation field 820, the corresponding field data may be displayed in the search result table 840 as the search result in a case where the periods partially overlap. This makes it possible to increase the amount of field data extracted and displayed under a search condition designated by the user.

Note that it is desirable to adopt a configuration in which the user can set whether the period of the field data to be searched is completely included in the period designated in the period designation field 820 or may have at least a partially overlapping period on a menu screen (not illustrated).

The context search processing has been described as above.

### (Automatic Data Deletion Processing)

Next, the automatic data deletion processing in step S600 will be described.

When the data management device 100 regularly acquires data from the field device 200, the storage capacity of the storage unit 120 becomes full, and it is not possible to store new field data. Therefore, the data management device 100 regularly executes the following automatic data deletion processing (S600 in FIG. 3).

In FIG. 7, the automatic data deletion function 193 of the field data management software 190 determines whether to perform the automatic field data deletion processing (S610). Specifically, the automatic data deletion function 193 uses the timer 113 to determine whether it is a timing to automatically delete field data. When it is not the timing to automatically delete field data (it is determined as NO in S610), the processing of this flowchart is ended.

On the other hand, when it is the timing to automatically delete field data as a result of the confirmation (it is determined as YES in S610), the automatic data deletion function 193 refers to the field data storage table 130 and confirms whether there is field data that needs to be deleted. If there is the field data to be deleted, the automatic data deletion function 193 deletes the corresponding data from the field data storage table 130 (S620). After the processing in step S630, the processing of this flowchart is ended.

Next, the automatic data deletion function 193 refers to the context assignment management table 150 and confirms whether a context has been assigned to the deleted field data. When the context has been assigned to the deleted field data, the automatic data deletion function 193 deletes the corresponding data from the context assignment management table 150 and updates the context assignment management table 150 (S630). After the processing in step S630, the processing of this flowchart is ended.

The automatic data deletion processing has been described as above. Thereafter, the data management device 100 appropriately executes the field data collection processing (S100), the field data acquisition processing (S200), the context registration processing (S300), the context assignment processing (S400), the context search processing (S500), and the automatic data deletion processing (S600). The data management by the data management device 100 according to the first embodiment of the present invention has been described as above.

As described above, the data management device (data management device 100) according to the first embodiment includes: a time series data management unit (the field data management software 190) that manages time series data (field data) generated in a target system; and a context management unit (the context management software 180) that manages a context registered by a user in association with the time series data managed by the time series data management unit. Then, the context management unit is configured to execute a process of extracting time series data associated with the context set as a search target by the user out of the managed time series data.

In the data management device according to the first embodiment configured as described above, the user can designate a type and a period of time series data (field data) and associate the time series data with a context selected by the user. Then, desired time series data can be searched using the context as a search keyword. Therefore, the data management device according to the present embodiment can search for specific data desired by the user from a large amount of time series data without impairing convenience of the user.

In addition, the data management device (data management device 100) according to the first embodiment includes: a user interface (the user interface 171) that receives an input of the user; and a context storage table (the context storage table 140) that stores the registered context. Then, the context management unit (context management software 180) causes the user interface to display a context registration screen (the context registration screen 600) configured to register the context on a terminal used by the user.

In addition, in the data management device (data management device 100) according to the first embodiment, the context management unit (context management software 180) causes the user interface (user interface 171) to display a context assignment screen (the context assignment screen 700), configured to assign the context to the time series data (field data) corresponding to a condition designated by the user, on the terminal used by the user.

In addition, in the data management device (data management device 100) according to the first embodiment, in a case where a type and a target period of time series data (field data) are designated by the user on the context assignment screen (context assignment screen 700) through the user interface (user interface 171), the context management unit (context management software 180) acquires the context stored in the context storage table (the context storage table 140), and displays the acquired context on the context assignment screen as a candidate (the context list 740) for a context to be assigned to the time series data for which the type and the target period are designated in a user-selectable manner.

### Second Embodiment

In the first embodiment described above, the field data collected from the field device 200 is stored in the field data storage table 130 (FIG. 1) of the data management device 100 without any change, and thus, the user needs to know a data name and the like generated by the field device 200 in advance. If the user is familiar with specifications of the field device 200, the field data can be acquired using the data name generated by the field device 200. However, many externally procured devices are used as the field device 200, and it is difficult for the user to grasp all of data names and the like generated by the field devices 200. Therefore, the data management device 100 needs to be configured to have a function of associating a data name generated by the field device 200 with a data name used when the user acquires data.

### [Configuration of Data Management Device]

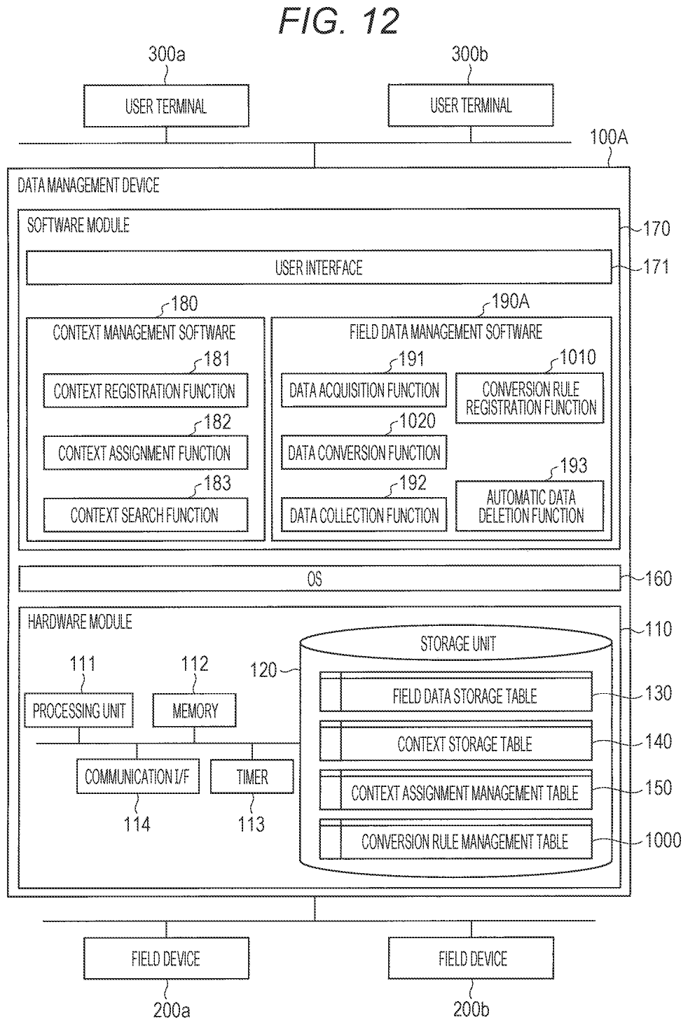

FIG. 12 is a block diagram illustrating an example of a configuration of a data management device according to a second embodiment of the present invention. A data management device 100A illustrated in the drawing has a function of associating a data name generated by the field device 200 with a data name used when the user acquires field data. Hereinafter, FIG. 12 will be described focusing on a difference from FIG. 1.

In this embodiment, a conversion rule management table 1000 is added to the storage unit 120 of the data management device 100A in comparison with the data management device 100 (FIG. 1). The conversion rule management table 1000 is a table that stores, as a rule, an association between a data name generated by the field device 200 and a data name used when the user acquires field data.

### (Structure of Conversion Rule Management Table)

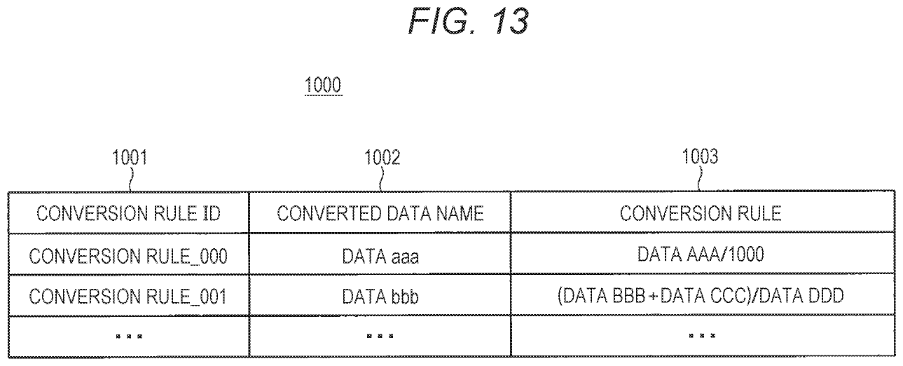

Next, a structure of the conversion rule management table 1000 will be described with reference to FIG. 13.

FIG. 13 is a table illustrating an example of the structure of the conversion rule management table 1000.

The conversion rule management table 1000 includes fields of “conversion rule ID 1001”, “converted data name 1002”, and “conversion rule 1003”.

The conversion rule ID 1001 is an identifier for uniquely identifying a conversion rule, and is an ID assigned by a conversion rule registration function 1010 when the user registers the conversion rule.

The converted data name 1002 is a data name used when the user acquires field data through the communication I/F 114. For example, in the converted data name 1002, data names that are easy for the user to understand, such as “Pressure of vicinity of pipe” and “Temperature of stirrer”, are registered.

The conversion rule 1003 includes a data name generated by the field device 200 for generating the converted data name 1002. In addition to the data name generated by the field device 200, a rule obtained by combining a plurality of the data names and operations generated by the field device 200 is stored in the conversion rule 1003. For example, a conversion rule “Data AAA/1000” having the conversion rule ID 1001 of “000” represents a unit conversion (corresponding to data content conversion) such as a conversion from meters to kilometers.

The conversion rule management table 1000 may be common to all the field devices 200 or may be created for each of the field devices 200. When being created for each of the field devices 200, the conversion rule management table 1000 to be used can be switched based on an identifier for identifying the field device 200 included in field data transmitted by the field device 200.

The structure of the conversion rule management table 1000 has been described above.

The description of the data management device 100A with reference to FIG. 12 will be continued.

### (Field Data Management Software)

In the data management device 100A, a conversion rule registration function 1010 and a data conversion function 1020 are added to field data management software 190A of the software module 170 as compared with the field data management software 190 (FIG. 1).

The context assignment function 182 may store the converted data name 1002 of the conversion rule management table 1000 in the context assignment management table 150 in addition to a data name of field data generated by the field device 200. This embodiment has a specification that does not allow the user terminal 300 to access the field data before conversion (for example, Data AAA in FIG. 13). The context assignment function 182 can assign a context only to the converted field data. With such a specification, it is possible to smoothly mange the field data before and the converted field data.

The context search function 183 may have a specification that allows the user to search for field data using the converted data name 1002 of the conversion rule management table 1000 in addition to a data name of the field data generated by the field device 200.

The conversion rule registration function 1010 is a function for registering a conversion rule in the conversion rule management table 1000 according to a user's operation on the user terminal 300.

The data conversion function 1020 refers to the conversion rule 1003 stored in the conversion rule management table 1000, and converts a data name used by the user to request data acquisition and a data name stored in the field data storage table 130.

### Example of Procedure of Data Management

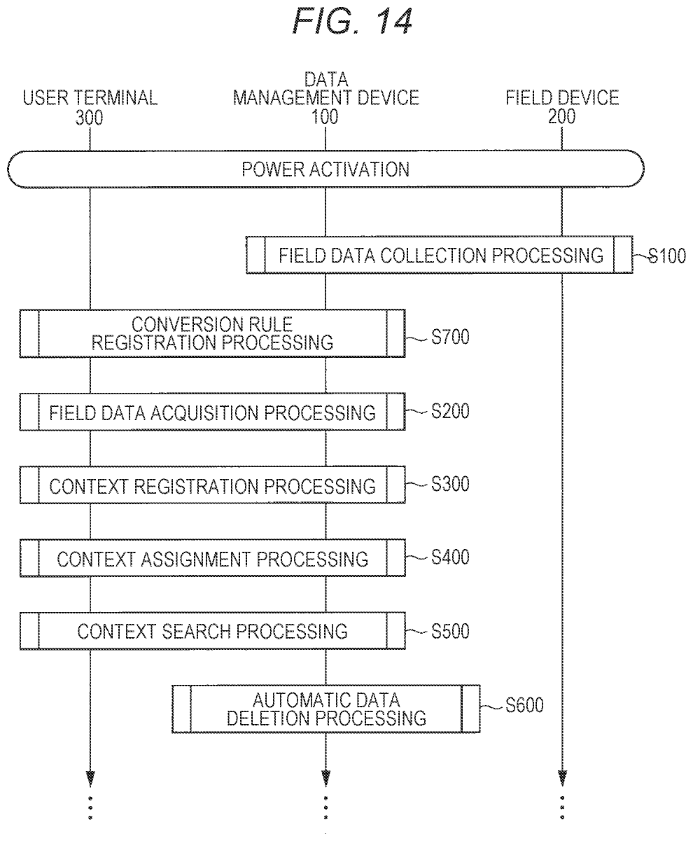

FIG. 14 is a sequence chart illustrating an example of a procedure of data management by the data management device 100A. The flowchart of FIG. 14 is different from that of FIG. 3 in that the data management device 100A executes conversion rule registration processing (S700) between the field data collection processing (S100) and the field data acquisition processing (S200).

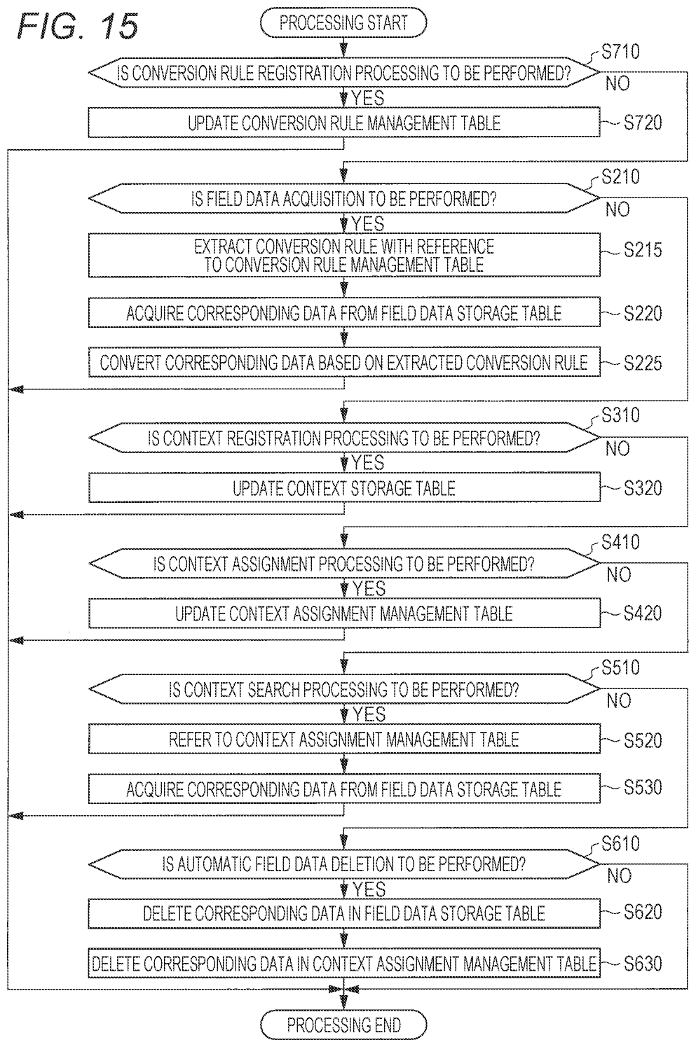

FIG. 15 is a flowchart illustrating an example of a procedure of the conversion rule registration processing (S700), the field data acquisition processing (S200), the context registration processing (S300), the context assignment processing (S400), and the context search processing (S500) which are performed by the data management device 100A. The flowchart of FIG. 14 is different from that of FIG. 3 in terms of including steps S710 and S720 and steps S215 and S225.

Next, the conversion rule registration processing in step S700 will be described.

When the user desires to register a conversion rule to be applied to field data through the user terminal 300, the following conversion rule registration processing is executed (S700 in FIG. 14).

In FIG. 15, the conversion rule registration function 1010 of the field data management software 190A determines whether to perform the conversion rule registration processing (S710). Specifically, the conversion rule registration function 1010 determines whether the data management device 100A has received a conversion rule registration request message from the user terminal 300 through the communication I/F 114. When the context registration request message has not been received (it is determined as NO in S710), the processing proceeds to step S210.

On the other hand, when the data management device 100A receives the conversion rule registration request message (it is determined as YES in S710), the conversion rule registration function 1010 updates a content of the conversion rule management table 1000 based on a content of the request (S720). After the processing in step S720, the processing of this flowchart is ended.

Next, the conversion rule registration processing in step S700 will be described.

In FIG. 15, the data acquisition function 191 of the field data management software 190 determines whether to perform field data acquisition (S210). Specifically, when the data acquisition function 191 determines that the data management device 100A has not received a field data acquisition request message from the user terminal 300 (it is determined as NO in S210), the processing proceeds to step S310.

On the other hand, when it is determined that the data management device 100A has received that the field data acquisition request message (it is determined as YES in S210), the data conversion function 1020 refers to the conversion rule management table 1000 and extracts a conversion rule related to field data corresponding to the field data acquisition request message (S215).

Next, the data acquisition function 191 refers to the field data storage table 130 and acquires the field data corresponding to the field data acquisition request message (S220). Next, the data conversion function 1020 applies the conversion rule extracted in step S215 to the field data acquired by the data acquisition function 191, and executes conversion processing of the corresponding field data (S225). Then, the data acquisition function 191 acquires the converted field data, generates a field data acquisition response message, and transmits the field data acquisition response message together with the converted field data to the user terminal 300 through the communication I/F 114.

After the processing in step S220, the processing of this flowchart is ended. Each processing in the other steps of the flowchart illustrated in FIG. 15 is the same as that of the flowchart illustrated in FIG. 7.

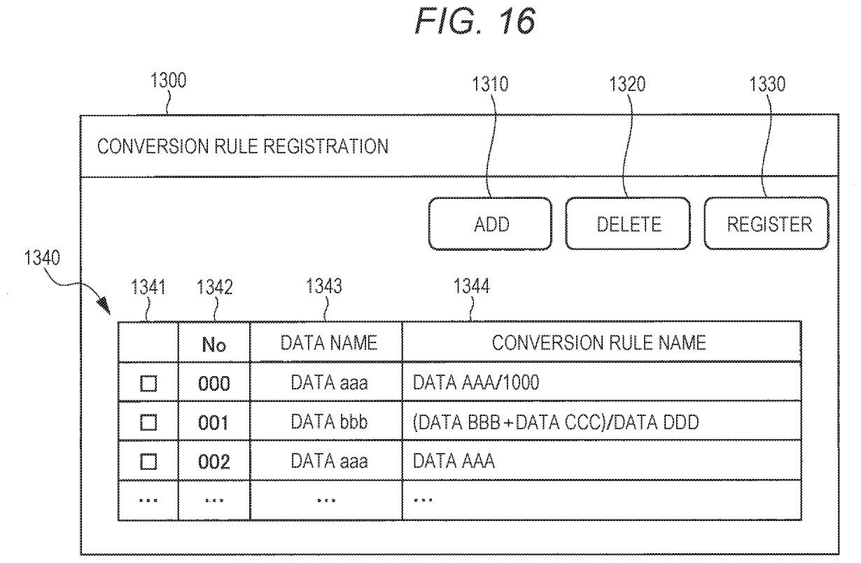

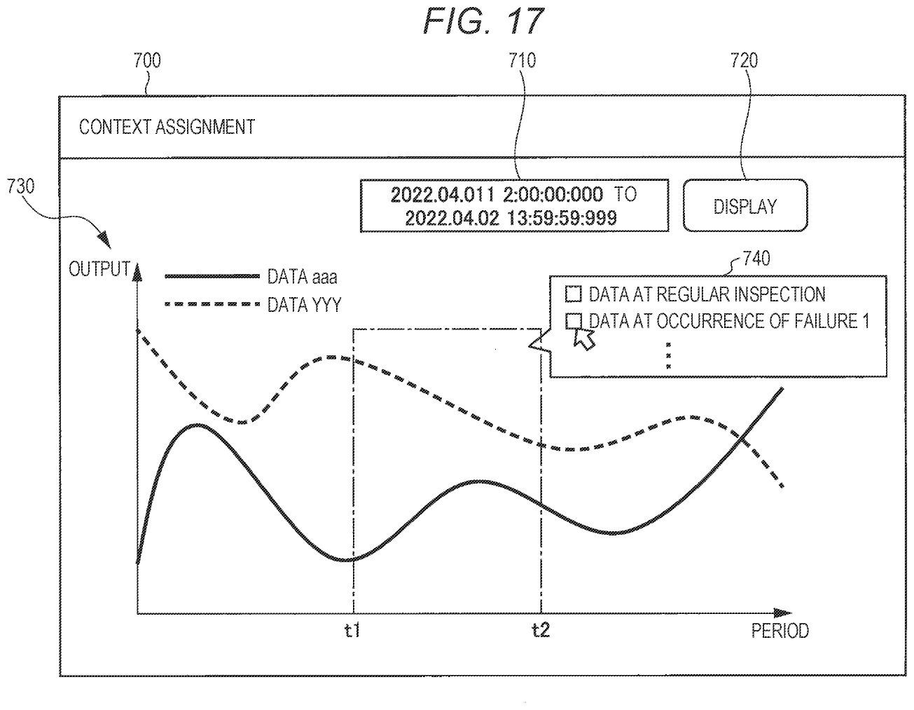

FIG. 16 is a view illustrating an example of a screen used in the conversion rule registration processing by the data management device 100A. FIG. 16 illustrates an example of a conversion rule registration screen 1300 prepared as the user interface 171 by the data management device 100A. The conversion rule registration screen 1300 is displayed on a display device of the user terminal 300. The same applies to FIG. 17 to be described later.

The conversion rule registration screen 1300 includes, for example, an add button 1310, a delete button 1320, a register button 1330, and a conversion rule registration table 1340. The conversion rule registration table 1340 includes fields of a check field 1341, a conversion rule number 1342, a data name 1343, and a conversion rule name 1344.

The check field 1341 includes a check box. The user can select a desired record by operating an input device of the user terminal 300 to put a check mark in the check box, which is similar to the check field 641 in FIG. 8.

The conversion rule number 1342 indicates a number of a record constituting the conversion rule registration table 1340. For example, when the conversion rule registration function 1010 adds a new record, a number obtained by adding “1” to the number of the current conversion rule number is assigned and displayed.

The data name 1343 is a data name to be displayed after a conversion rule is applied. The data name 1343 corresponds to the converted data name 1002.

In the conversion rule name 1344, for example, a conversion rule name desired to be registered by the user can be input by a free word. For example, FIG. 16 illustrates that “Data name “Data AAA” is converted into “Data aaa” and displayed” as an example of a conversion rule in a record having the conversion rule number 1342 of “002”. A display content of the conversion rule name 1344 may be the same as a content of the conversion rule 1003. Note that it may be configured such that a plurality of conversion rule candidates are prepared in advance to allow the user to select a conversion rule to be registered from among the conversion rule candidates displayed in a pull-down menu or the like.

When the user presses the add button 1310 on the conversion rule registration screen 1300, a new column (record) is added to the conversion rule registration table 1340, and a new conversion rule can be registered.

When the user presses the delete button 1320, the conversion rule registration function 1010 deletes a conversion rule selected in the conversion rule registration table 1340 from the conversion rule management table 1000 through the user interface 171.

In addition, when the user presses the register button 1330, the conversion rule registration function 1010 stores a content, set in a data name and a conversion rule of the conversion rule registration table 1340 by the user, in the conversion rule management table 1000 through the user interface 171.

FIG. 17 is a view illustrating a context assignment screen as a display example of the data name of the field data after the conversion rule is applied. In the graph 730 of the context assignment screen 700 illustrated in the drawing, the data name “Data AAA” of the context assignment screen 700 of FIG. 10 is converted into “Data aaa”. In this display example, the conversion rule having the conversion rule number of “002” illustrated in FIG. 16 is applied. Note that, in a conversion rule that is not a simple data name conversion, it may be considered that a waveform of field data displayed in the graph 730 differs before and after the conversion by passing through a unit conversion and an arithmetic expression.

Although an example of the user interface 171 using the conversion rule registration screen 1300 has been described in this embodiment, an interface other than the screen may be used.

The conversion rule registration processing has been described as above.

As described above, in the data management device (the data management device 100A) according to the second embodiment, a time series data management unit (the field data management software 190A) acquires a conversion rule (for example, the conversion rule 1003 and the converted data name 1002) in which an association between time series data (field data) generated in a target system and time series data used by a user for a search is registered, and converts time series data (field data) managed by a context management unit (the context management software 180) in accordance with the acquired conversion rule. Then, the context management unit is configured to execute a process of extracting time series data associated with a context set as a search target by the user out of the converted time series data.

In the data management device according to the second embodiment configured as described above, it is possible to associate the time series data (field data) generated in the target system with the time series data used for the search by the user using the conversion rule described above. As a result, the user can perform the search operation using the time series data, which has been registered in advance to be used for the search by the user, without knowing all names and the like of the time series data generated by the target system in advance.

In addition, the data management device (data management device 100A) according to the second embodiment includes: a user interface (the user interface 171) that receives an input of the user; and a conversion rule management table (the conversion rule management table 1000) that stores and manages the conversion rule. Then, the time series data management unit (field data management software 190A) causes the user interface to display a conversion rule registration screen (the conversion rule registration screen 1300) configured to register the conversion rule on a terminal used by the user.

In addition, in the data management device (data management device 100A) according to the second embodiment, at least one of a name conversion of the time series data (field data) managed by the context management unit (context management software 180), a unit conversion of the time series data, and an arithmetic expression using the time series data is defined as the conversion rule.

In the first and second embodiments described above, a data management target can be not only a field device that monitors a machine tool or the like but also an apparatus or a system provided with a large number of devices. For example, examples of the data management target system include a social infrastructure system such as a railway and electric power/gas, a manufacturing plant, and the like.

The present invention is not limited to the above first and second embodiments, and it is a matter of course that various other applications and modifications can be made without departing from a gist of the present invention described in the claims. For example, the above first and second embodiments describe the detailed and concrete description of the configuration of the data management device in order to describe the present invention in an easily understandable manner, and are not necessarily limited to one including all constituent elements that have been described above. In addition, it is also possible to make addition, substitution, or deletion of other constituent elements regarding some configurations of the above first and second embodiments.

In addition, a part or all of each of the above-described configurations, functions, processing units, and the like may be implemented, for example, by hardware by designing with an integrated circuit and the like. As the hardware, a processor device in a broad sense such as a field programmable gate array (FPGA), an application specific integrated circuit (ASIC), or the like may be used.

In addition, each constituent element of the data management devices according to the above first and second embodiments may be mounted to any hardware as long as the respective pieces of hardware can transmit and receive information to and from each other via a network. In addition, a process performed by a certain function or processing unit may be implemented by a single piece of hardware, or may be implemented by a distributed process using a plurality of pieces of hardware.

In addition, a plurality of processes may be executed in parallel or the processing order may be changed within a range not affecting the processing result in each of the above flowcharts.

What is claimed is:

1. A data management device comprising:
a time series data management unit that manages time series data generated in a target system; and
a context management unit that manages a context registered by a user in association with the time series data managed by the time series data management unit,
wherein the context management unit executes a process of extracting time series data associated with the context set as a search target by the user out of the managed time series data.

2. The data management device according to claim 1, further comprising:
a user interface that receives an input of the user; and
a context storage table that stores the registered context,
wherein the context management unit causes the user interface to display a context registration screen configured to register the context on a terminal used by the user.

3. The data management device according to claim 2, wherein
the context management unit causes the user interface to display a context assignment screen, configured to assign the context to the time series data corresponding to a condition designated by the user, on the terminal used by the user.

4. The data management device according to claim 3, wherein
in a case where a type of the time series data and a target period are designated by the user on the context assignment screen through the user interface, the context management unit acquires the context stored in the context storage table, and displays the acquired context on the context assignment screen as a candidate for a context to be assigned to the time series data for which the type and the target period are designated in a user-selectable manner.

5. The data management device according to claim 1, wherein
the time series data management unit acquires a conversion rule in which an association between the time series data generated in the target system and time series data used for search by the user is registered, and converts the time series data managed by the context management unit in accordance with the conversion rule, and
the context management unit executes a process of extracting time series data associated with the context set as a search target by the user out of the converted time series data.

6. The data management device according to claim 5, further comprising:
a user interface that receives an input of the user; and
a conversion rule management table that stores and manages the conversion rule,
wherein the time series data management unit causes the user interface to display a conversion rule registration screen configured to register the conversion rule on a terminal used by the user.

7. The data management device according to claim 6, wherein
at least one of a name conversion of the time series data managed by the context management unit, a unit conversion of the time series data, and an arithmetic expression using the time series data is defined as the conversion rule.

8. A program for causing a computer, provided in a data management device that manages time series data generated in a target system, to execute:
managing a context registered by a user in association with the time series data;
receiving the context to be searched out of the time series data from the user; and
extracting time series data associated with the context set as a search target by the user.
